(19) United States
(12) Patent Application Publication
(10) Pub. No.: US 2013/0168392 A1
(43) Pub. Date: Jul. 4, 2013

(54) Fuel Filler Port

(71) Applicant: Asteer Co., Ltd., Soja-shi (JP)

(72) Inventors: Masahiro Kuyama, Soja-shi (JP); Takami Ono, Soja-shi (JP)

(73) Assignee: Asteer Co., Ltd., Soja-shi (JP)

(21) Appl. No.: 13/712,245

(22) Filed: Dec. 12, 2012

(30) Foreign Application Priority Data
Dec. 28, 2011 (JP) JP2011-287270

(51) Int. Cl. B60K 15/04

(52) U.S. Cl. CPC B60K 15/04
USPC 220/86.2

(57) ABSTRACT

Present invention provides a fuel filler port preventing a flowing back fuel from overflowing from the fuel filler port. The fuel filler port includes a first member and a second member. The first member and the second member are provided from upward to downward direction in written order. The second member is provided with a plurality of guiding projections and a fuel outlet provided between the adjacent projections. Since an inner diameter of the first opining is equal to an outer diameter of the fuel filler nozzle inserted, the flowing back fuel hardly flows through a gap between the first opening and the fuel filler nozzle. The flowing back fuel is discharged to the outside of a fuel filler pipe via the fuel outlet.

### BACKGROUND OF THE INVENTION

1. Field of the Invention

Present invention relates to a fuel filler port preventing a fuel from overflowing when the fuel is fed.

2. Description of the Related Art

When a fuel is fed into a fuel tank of a vehicle, a fuel nozzle is inserted into a fuel filler port, and the fuel is supplied from the fuel filler port to the fuel tank via a fuel filler pipe. The fuel nozzle automatically stops supplying the fuel when the fuel tank is filled-up. The fuel filler nozzle stops supplying the fuel by detecting a pressure change within the fuel tank with a sensor. The pressure change is caused by changing of a liquid level of the fuel tank. However, a refueling operator often manually top the fuel tank up with the fuel by manually adding the fuel since a feeding of the fuel does not properly stop when the fuel tank is filled-up depending on the type of vehicles. When the operator manually tops the fuel tank up with the fuel, the fuel is swiftly discharged from the fuel nozzle and overflows from the fuel filler port to spill over the operator. A malfunction of the sensor causes the same kind of troubles.

A fuel filler port disclosed in PCT International Publication No. WO2010/029989A1 closes an opening of the fuel filler port with a shutter 26 provided therein. In case the shatter 26 does not open for some reasons, an end of the fuel filler nozzle is blocked with the shatter 26. This may cause the fuel to overflow form the fuel filler port. In the fuel filler port of WO2010/029989A1, a flow path having a complex structure so called “labyrinth” is provided between the opening of fuel filler port 73 and the shutter 26. The labyrinth 81 weakens a flashing fuel to slowly discharge from the opening of the fuel filler port.

In the fuel filler port of the WO2010/029989A1, a first and second portioning parts 28, 52 are provided between the shutter 26 and the opening of fuel filler port 73 for allowing the fuel filler nozzle to pass therethrough. The first partitioning part 28 provided around a first opening 65 has at least one first hollow part 68 of a predetermined circumferential width. The second partitioning part 52 provided around a second opening 61 has at least one second hollow part 76 of a predetermined circumferential width. The first and second hollow parts 68, 76 are arranged in a circumferentially different position to each other thereby to form a labyrinth 81 between the shutter 26 and the opening of the fuel filler port 73. As shown in claim 3 and FIG. 8b, chamfered parts 75 are formed on a corner of the second opening 61 to reduce a flow velocity of the fuel.

The fuel filler port of WO2010/029989A1 merely weakens the flashing fuel. The fuel possibly still discharges from the fuel filler port as indicated by an arrow H in FIG. 9 (b). Therefore, the fuel possibly spills over the operator if the flashing fuel does not enough weaken.

### SUMMARY OF THE INVENTION

Present invention provides a fuel filler port preventing a flowing back fuel from overflowing from the fuel filler port. Such a fuel filer port is realized by a fuel filler port to be installed on an end of a fuel filler pipe communicated with a fuel filler tank. The fuel filler port includes a first member placed across an inserting direction of the fuel filler nozzle and provided with a first opening for inserting the fuel filler nozzle. An inner diameter of the first opining is equal to an outer diameter of the fuel filler nozzle. The fuel filler port further includes a second member placed across an inserting direction of the fuel filler nozzle. The second member is provided with a second opening for inserting the fuel filler nozzle, a plurality of guiding projections forming a space for guiding the fuel filler nozzle to the fuel filler pipe and intermittently projecting from a peripheral edge of the second opening, a protruding opening protruding radially-outwardly from the second opening and provided between the adjacent guiding projections, and a fuel outlet provided between the adjacent guiding projections and communicating with a space enclosed by said guiding projections and a space outside the fuel filler pipe. In the fuel filler port of this invention, the first member and the second member is provided from upward to downward in written order. According to the present invention, a flowing back fuel is discharged through the protruding opening and the fuel outlet to the outside.

A tip of the fuel filler nozzle is inserted into the fuel filler pipe through an opening edge of the filler neck, the first opening of the first member and the second opening of the second member. The first member is configured so that an inner diameter of the first opening is equal to the outer diameter of the fuel filler nozzle. A term “equal” in this invention means an inner edge of the first opening and an outer edge of the fuel filler nozzle are as close as a gap hardly forms therebetween. However, it does not always mean that a size of the inner diameter of the first opening and a size of the outer diameter of the fuel filler nozzle is exactly same. The size of the inner diameter of the first opening may be a little larger than the size of the outer diameter of the fuel filler nozzle. In other words, the inner diameter of the first opening is configured so that a pressure of the fuel managing to pass through a gap between the first opening and the fuel filler nozzle becomes large. The second member includes the fuel outlet provided between the plurality of guiding projections. Therefore the flowing back fuel hardly flows to the first opening and an inner surface of the guiding projection where the pressure becomes high, and the flowing back fuel gathers to the fuel outlet. As a result, the fuel is discharged outside through the fuel outlet. Use of the term “equal” is applicable to the other descriptions on the present invention too.

In the fuel filler port of the present invention, it is preferable that the second member may further include a chamber communicating with the space enclosed by the guiding projections via the fuel outlet, and a second fuel outlet provided within the chamber to communicate with the space outside the fuel filler pipe. The chamber temporarily retains the flowing back fuel. The retained fuel flows back to the fuel filler pipe again after a liquid level of the fuel filler piper lowers.

In case the chamber is provided, the fuel temporarily retained in the chamber possibly flows back to the space enclosed by the plurality of guiding projections. Therefore, it is preferable that a flow changing block is provided outside of the fuel outlet. The flow changing block collides with a fuel run off from the fuel outlet and changes a flow direction to the circumferential direction. The flow changing block prevents the fuel from flowing back into the space enclosed by the guiding projections while allowing the fuel to run off from the fuel outlet by weakening the flushing fuel run of f from the outlet by colliding therewith. Therefore, the fuel temporarily retained in the chamber is prevented from flowing back to the space.

A configuration of the second member varies depending on a configuration of the guiding projections. For example, the guiding projections radially-inwardly protrude from a peripheral face of a cylindrical wall whose inner diameter is larger than outer diameter of the fuel filling nozzle, and the fuel outlet is provided on the peripheral surface on which the guiding projections are not provided, as in aforementioned embodiment 1.

Alternatively, the configuration of the guiding projection may be as follows. The fuel outlet is provided on a peripheral surface of a cylindrical wall whose inner diameter is equal to an outer diameter of the fuel filling nozzle, and the guiding projections are the remaining cylindrical walls which are not provided with the fuel outlet, as in aforementioned embodiments 2 and 3.

Alternatively, the configuration of the guiding projection may be as follows. The second opening is provided with a plurality of projecting peripheral surfaces and a plurality of concaved peripheral surfaces, the projecting peripheral surfaces and the concaved peripheral surfaces are combined and aligned alternately in circumferential direction of the second opening. A distance between the opposing concaved peripheral surfaces is larger than an outer diameter of the fuel filling nozzle and an outer diameter of a lower end of the first member. A distance between inner surfaces of the opposing projecting peripheral surfaces is equal to the outer diameter of the fuel filling nozzle. In this case, projecting peripheral surfaces function as the guiding projections. An opening between an upper end of the concaved peripheral surface and the lower end of the first member function as the fuel outlet, as in aforementioned embodiment 4. A fuel filler nozzle is inserted into the space surrounded by the projecting peripheral surfaces and the concaved peripheral surfaces.

The fuel filler port of present invention is preferably provided with a shatter. In this case, the guiding projections radially-inwardly protrude from a peripheral edge of second opening to form a protruding opening between the adjacent guiding projections, and the protruding opening is communicated with the second opening. Above said shatter is pressed against the second opening and the protruding opening as a valve sheet. In case the fuel filler nozzle is inserted into the second opening, the protruding opening allows to pass the flowing back fuel therethrough. In case the fuel filler nozzle is not inserted, the shutter seals the second opening and the protruding opening and assures a gas tight.

According to the fuel filler port of the present invention, the flowing back fuel does not overflow from the opening edge of the fuel filler port. The flowing back fuel does not spill over the refueling operator since the flowing back fuel discharged through the fuel outlet. This is because the fuel hardly passes through the gap between the first opening and the fuel filler nozzle, and the gap between the guiding projection and the first opening since the pressure becomes high at the gaps. A periphery of the fuel filler port is not polluted with the fuel since the flowing back fuel does not overflow from the opening edge of the fuel filler port.

### BRIEF DESCRIPTION OF THE DRAWINGS

FIG. 1 is a perspective view illustrating an appearance of a fuel filler port of a first embodiment.

FIG. 2 is a vertical cross sectional view of the fuel filler port of the first embodiment.

FIG. 3 is a plain view of the fuel filler port of the first embodiment.

FIG. 4 is a perspective illustrating an appearance of a second member configuring the fuel filler port of the first embodiment. For a convenience of explanation, a status is illustrated in which a shatter is pressed down and is opened.

FIG. 5 is a vertical cross sectional view of the fuel filler port of the first embodiment to which a fuel filler nozzle is inserted.

FIG. 6 is a transverse cross sectional view of the fuel filler port of the first embodiment to which the fuel filler nozzle is inserted.

FIG. 7 is a vertical cross sectional view corresponding to FIG. 2 illustrating a fuel filler port of a second embodiment.

FIG. 8 is a perspective view corresponding to FIG. 4 illustrating an appearance of a second member configuring the fuel filler port of the second embodiment. For a convenience of explanation, a status is illustrated in which a shatter is pressed down and is opened.

FIG. 9 is a vertical cross sectional view corresponding to FIG. 5 illustrating the fuel filler port of the second embodiment to which a fuel filler nozzle is inserted.

FIG. 10 is a transverse cross sectional view corresponding to FIG. 6 illustrating the fuel filler port of the second embodiment to which the fuel filler nozzle is inserted.

FIG. 11 is a vertical cross sectional view corresponding to FIG. 2 illustrating a fuel filler port of a third embodiment.

FIG. 12 is a perspective view corresponding to FIG. 4 illustrating an appearance of a second member configuring the fuel filler port of the third embodiment. For a convenience of explanation, a status is illustrated in which a shatter is pressed down and is opened.

FIG. 13 is a vertical cross section corresponding to FIG. 5 illustrating the fuel filler port of the third embodiment to which a fuel filler nozzle is inserted

FIG. 14 is a transverse cross sectional view corresponding to FIG. 6 illustrating the fuel filler port of the third embodiment to which the fuel filler nozzle is inserted.

FIG. 15 is a vertical cross sectional view corresponding to FIG. 2 illustrating a fuel filler port of a fourth embodiment.

FIG. 16 is a perspective view corresponding to FIG. 4 illustrating an appearance of a second member configuring the fuel filler port of the fourth embodiment. For a convenience of explanation, a status is illustrated in which a shatter is pressed down and is opened.

FIG. 17 is a vertical cross sectional view corresponding to FIG. 5 illustrating the fuel filler port of the fourth embodiment to which a fuel filler nozzle is inserted.

FIG. 18 is a transverse cross sectional view corresponding to FIG. 6 illustrating the fuel filler port of the fourth embodiment to which the fuel filler nozzle is inserted.

### DETAILED DESCRIPTION OF THE PREFERRED EMBODIMENTS

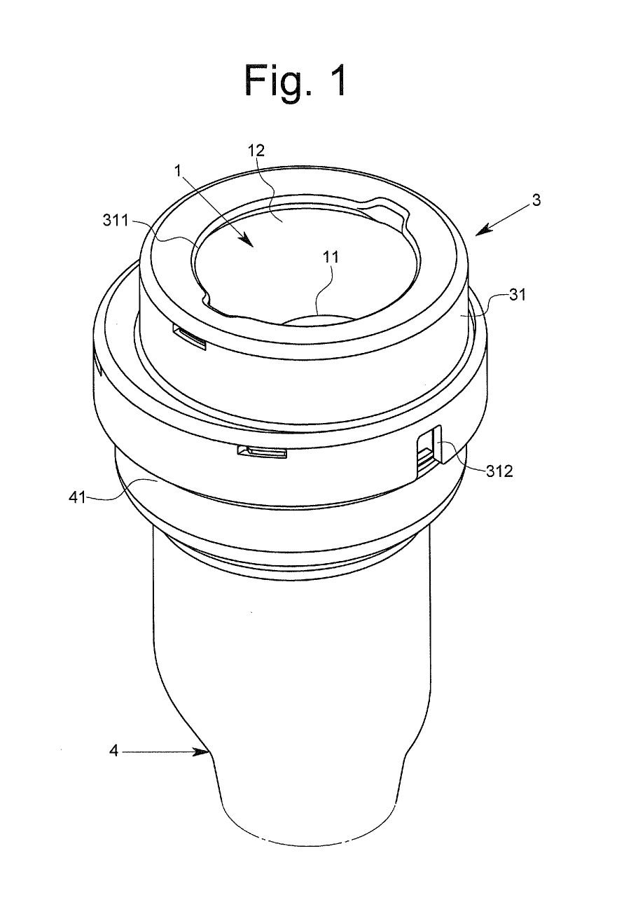

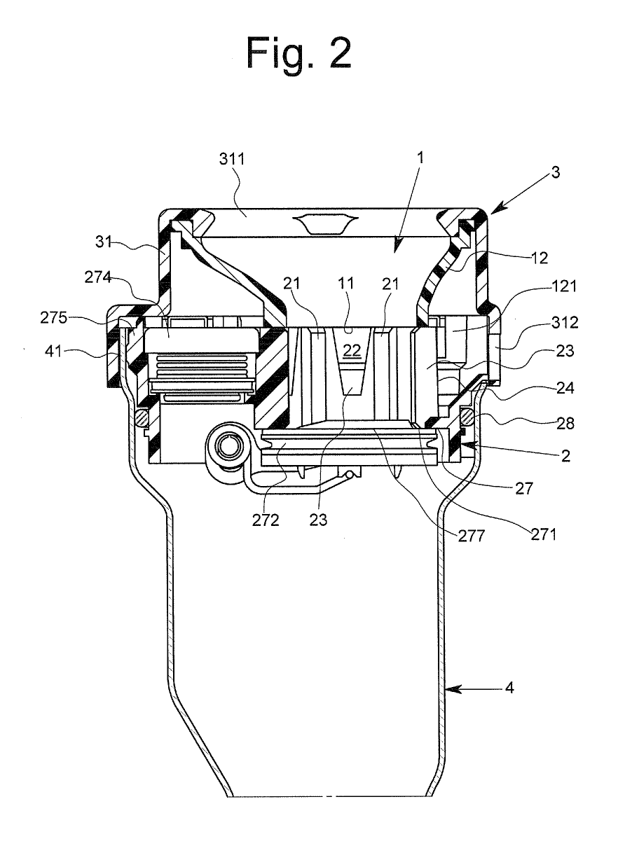

Embodiments of the present invention are explained below with reference to the Figures. For example, present invention is applied to a fuel filler port 3 including a shatter 272 as illustrated in FIGS. 1 to 18. The shatter 272 automatically closes and opens a second opening 277. Although an opening edge 3 is always exposed in FIG. 2 and other Figs, a cap, which is not illustrated in FIG. 2 and others, may be adapted to prevent dusts from entering the fuel filler port 3. In case the cap is adapted, a thread groove for screw fitting the cap is cut on inner surface of a funnel-shaped member (hereinafter referred to as a funnel 12).

Each embodiment is explained below.

### FIRST EMBODIMENT OF FIGS. 1 TO 6

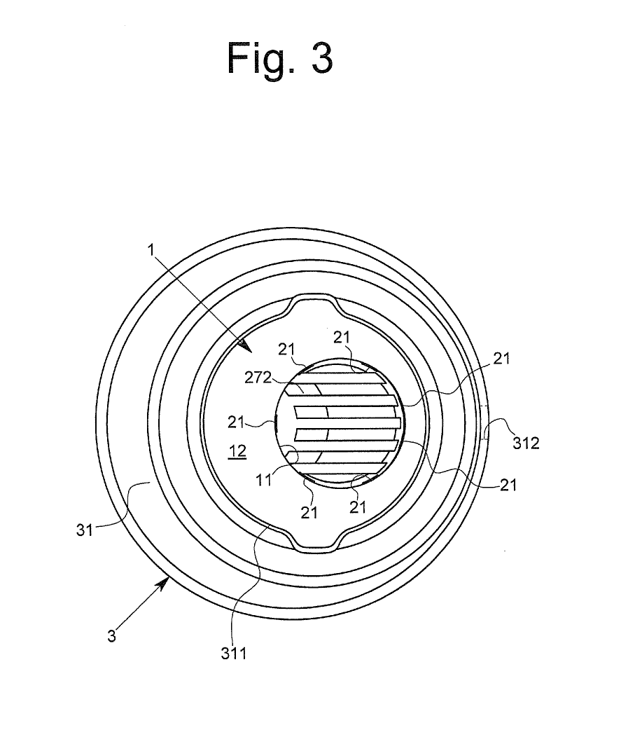

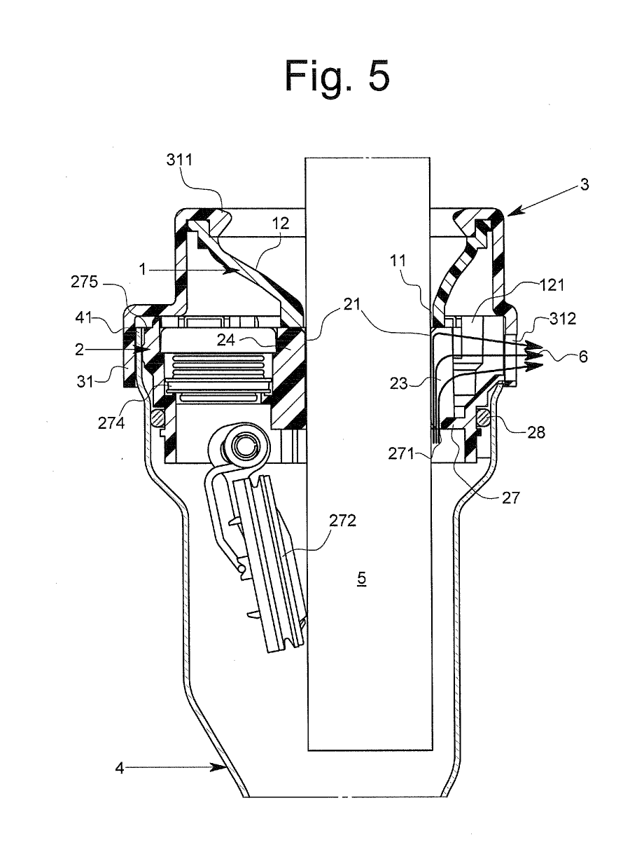

A first member 1 is a funnel-shaped member (funnel 12) and has a first opening 11 at its lower end. The first opening 11 is configured so that an inner diameter is equal to an outer diameter of a fuel filling nozzle 5. Therefore, when the fuel filler nozzle 5 is inserted as illustrated in FIG. 5, there is hardly any gap between the nozzle 5 and the first opening 11. The first member 1 has a housing 31. The housing 31 has a shape piling a small hollow cylinder and a large hollow cylinder whose diameter are different each other in stepwise manner. The housing 3 has the opening edge 311. The opening edge 311 is configured so that its inner diameter is larger than the outer diameter of the fuel filling nozzle 5. The funnel 12 and housing 31 may be either integrally shaped or separately shaped. In case the housing 31 and the funnel 12 are separately shaped, the housing 31 and the funnel 12 are connected by fitting the upper end of the funnel 12 into a rolled portion of the opening edge 311 so that the opening edge 311 of the housing 31 and the upper edge of the funnel 12 are communicated with each other. A center of the first opening 11 is eccentric with respect to a center of a circle of the opening edge 311 as illustrated in FIG. 3.

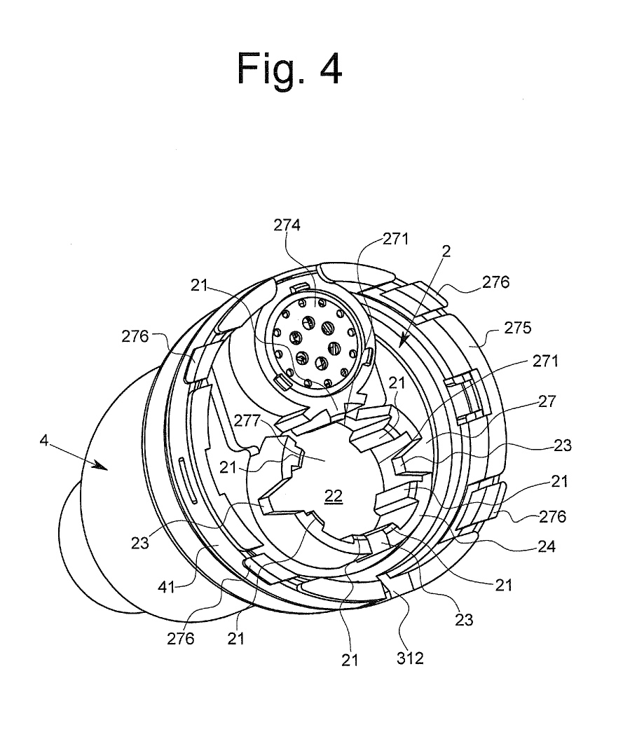

A second member 2 includes a bottom plate 27, a circular wall 275 provided around the bottom plate 27 and abating against an end portion 41 of a fuel filler pipe 4 when the second member 2 is fitted into the fuel filler pipe 4, the second opening 277 penetrating the bottom plate 27 in vertical direction, a cylindrical wall 24 projecting from the bottom plate 27 to enclose the second opening 277, and a plurality of guiding projections 21 intermittently provided on a peripheral face of the cylindrical wall 24 in the circumferential direction and forming a space 22 for guiding the fuel filler nozzle 5 to the fuel filler pipe 4. The second member 2 is fitted into the end portion 41 of the fuel filler pipe 4. The pipe 4 is enlarged in stepwise manner to prevent a thickness of the pipe 4 from locally thinning. As illustrated in FIG. 4, the second opening 277 has a protruding opening 271 which projects to radially outward. When the fuel filler nozzle 5 is inserted through the second opening 277, a gap (the protruding opening 271) is formed at the second opening 277, namely between the fuel filler nozzle 5 and the bottom plate 27 as illustrated in FIG. 5. The gap allows the flowing back fuel to flow therethrough. The second member 2 is provided with a shatter 272 biased upwardly by a torsion coil spring. The second opening 277 and the protruding opening 271 are closed with the shutter 272 as illustrated in FIG. 2 when the fuel filler nozzle 5 is not inserted. The shutter 272 is downwardly rotated and opened by being pushed with the fuel filler nozzle 5 as illustrated in FIG. 5. In order to depict a shape of the protruding opening 271, a state where the shutter 272 is downwardly pushed and opened is illustrated in FIG. 4.

A seal ring 28 is installed on an outer circumference of the circular wall 275 of the second member 2. The seal ring 28 airproofs the fuel filler pipe 4 by closely contacting with an inner wall of the fuel filler pipe 4. The second member 2 is fitted into the end portion 41 of the fuel filler pipe 41 until the second member 2 is entirely accommodated in the end portion 41. The second member 2 is provided with a valve 274 for adjusting a pressure of an inside of the fuel filler pipe 4 in the immediate vicinity of the second opening 277. In case a fuel filler port adapts a screw-in cap instead of the shutter 272, the valve 274 may be built into the screw-in cap.

The circular wall 275 has four engaging pieces 276 formed by cutting its wall from an upper edge to downward at eight portions. The engaging pieces 276 engage with an inner face a lower cylindrical portion of the housing 31. The engaging pieces 276 also engage with the end portion 41 and determine a position of the second member 2 with respect to the fuel filler pipe 4 when the second member 2 is fitted into the end portion 41 since a tip of the engaging pieces 41 position at radially-outward. The housing 31 is installed on the fuel filler pipe 4 as follows. An upper end of the first member 1 is fitted into an inside of a folded portion of the opening end 311. The lower cylindrical portion of the housing 31 is externally fitted with the end portion 41 which accommodates the second member 2. A space is formed between an outer face of the cylindrical wall 24, which is provided on the second member 2, and an inner face of the housing 31. This space functions as a chamber 121 temporarily accommodates the flowing back fuel. The camber 121 is communicated with the outlet 23 provided between the adjacent guiding projections 21 as described below. The chamber 121 is enclosed by the lower cylindrical portion of the housing 31. A second outlet 312 is formed on the lower cylindrical portion of the housing 31. The second outlet 312 is a through hole penetrating the circular wall 275 and the end portion 41 of the fuel filler pipe 4 (FIG. 4). The chamber 121 communicates with an outside of a fuel filler pipe 4 via the second outlet 312 and discharging the flowing back fuel therethrough.

The second member 2 of the first embodiment has a cylindrical wall 24 whose inner diameter is larger than an outer diameter of a fuel filler nozzle 5. The cylindrical wall 24 projects from a bottom plate 27 so that the cylindrical wall 24 encloses the second opening 277. The cylindrical wall 24 is provided with the plurality of guiding projections 21 radially-inwardly projecting from its peripheral surface. The guiding projections 21 are intermittently provided in a peripheral direction of the cylindrical wall 24, and elongate parallel to an inserting direction of the fuel filler nozzle 5. The cylindrical wall 24 which is not provided with the guiding projections 21 is the outlet 23. In other words, the outlet 23 is a partial opening extending from an upper end of the cylindrical wall 24 as illustrated in FIG. 4. A space is formed between the adjacent guiding projections 21 when the fuel filler nozzle 5 is inserted. This space functions as a buffer space.

The fuel filler nozzle 5 inserted from the opening edge 311 passes through the first opening 11, a space enclosed by the guiding projections 21 and the second opening 277. The shatter 272 is pressed and downwardly opened with an end of the fuel filler nozzle 5 to insert the tip of the fuel filler nozzle 5 into the fuel filler pipe 4. The first member 1 is configured so that an inner diameter of the first opening 11 is equal to an outer diameter of the fuel filler nozzle 5. A distance between opposing inner surfaces of the guiding projections 21 is also made equal to the outer diameter of the fuel filler nozzle 5. Therefore, the fuel filler nozzle 5 is securely guided to the second opening 277 being guided by the first opening 11 and the guiding projections 21. Further, the fuel filler nozzle 5 does not bump while refueling since the fuel filler nozzle 5 is securely supported by the first opening and the guiding projections 21. Therefore, an inner peripheral edge of the second opening 277 which functions as a sealing surface is not damaged with the fuel filler nozzle 5.

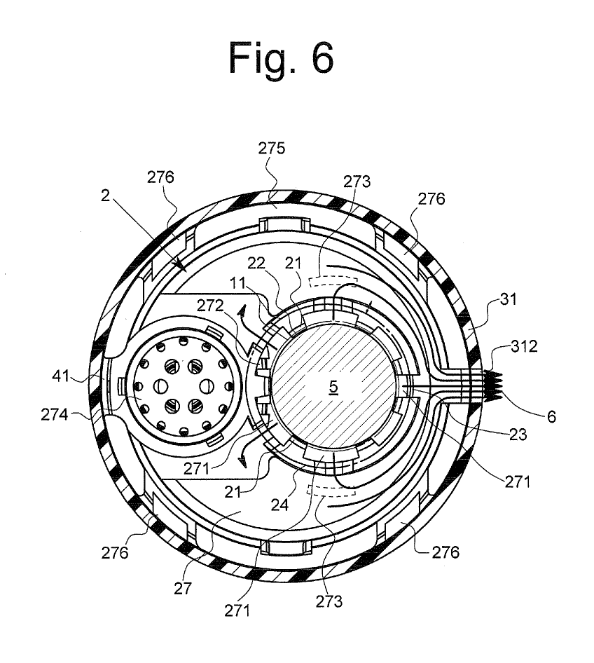

Since the inner diameter of the first opening 11 and the distance between the opposing guiding projections 21 are close to the outer diameter of the fuel filler nozzle 5, a pressure of the flowing back fuel 6 rises near the first opening 11 and the guiding projections 21. The outlet 23 is provided between the guiding projections neighboring in the circumferential direction of the cylindrical wall 24. As illustrated in FIGS. 5 and 6, the flowing back fuel 6 escapes and flows into the chamber 121 via the outlet 23 since the flowing back fuel hardly flows between the fuel filler nozzle 5 and the first opening 11 and between the fuel filler nozzle 5 and an inner surface of the guiding projection 21 where the pressure becomes high. The flowing back fuel 6 flows into the chamber 121 via the protruding opening 271 and the outlet 23. The flowing back fuel 6 is discharged from the chamber 121 to the outside of the fuel filler pipe 4 via the second outlet 121. Therefore, the flowing back fuel 6 does not overflow from the opening end 31 according to the fuel filler port 3 of the first embodiment.

The fuel 6 once flowing into the chamber 121 possibly flows back to the space 22 enclosed by the plurality of guiding projections 21 via the outlet 23. In order to prevent this, a flow changing block 273 is preferably provided at radially-outside of the outlet 23 as illustrated with a broken line in FIG. 6. The flow changing block 273 collides with the fuel 6 flowing out thorough the outlet 23 and changes direction to a circumferential direction. A flow changing block 273 exemplified in FIG. 6 is a plate laid along a periphery of a circle larger than the cylindrical wall 24 and having the same center as the cylindrical wall 24. Since the flow changing block 273 provided to face the outlet 23, the flow changing block 273 configures a sort of labyrinth. The flow changing block 273 guides the fuel 6 flowing out through the outlet 23 to the second outlet 312 and prevents the fuel 6 from flowing back into the space 22 while weakening the flushing fuel.

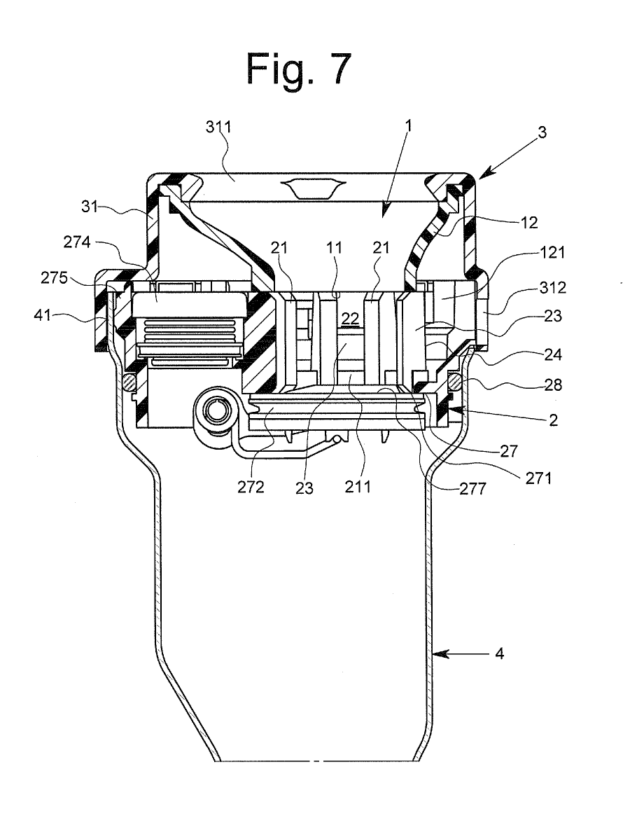

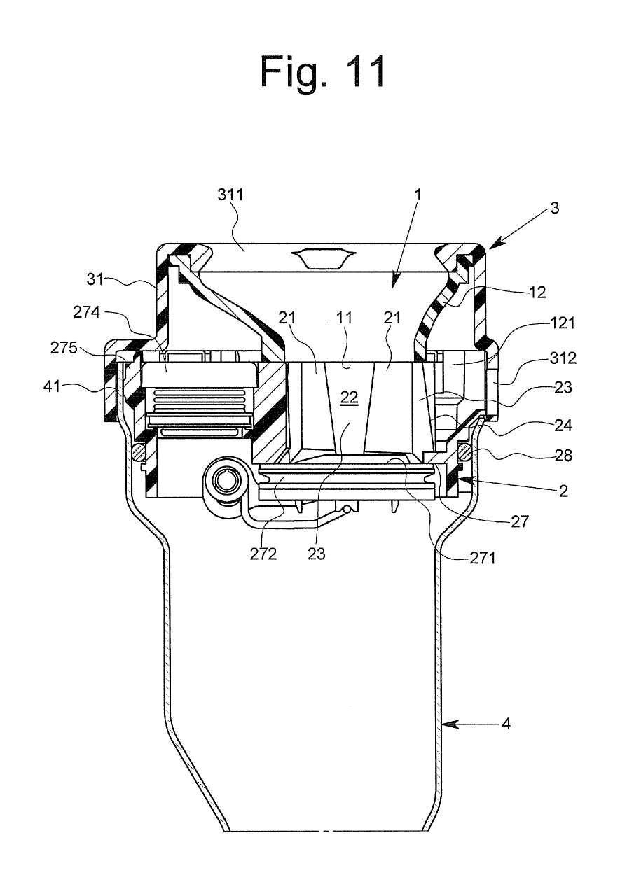

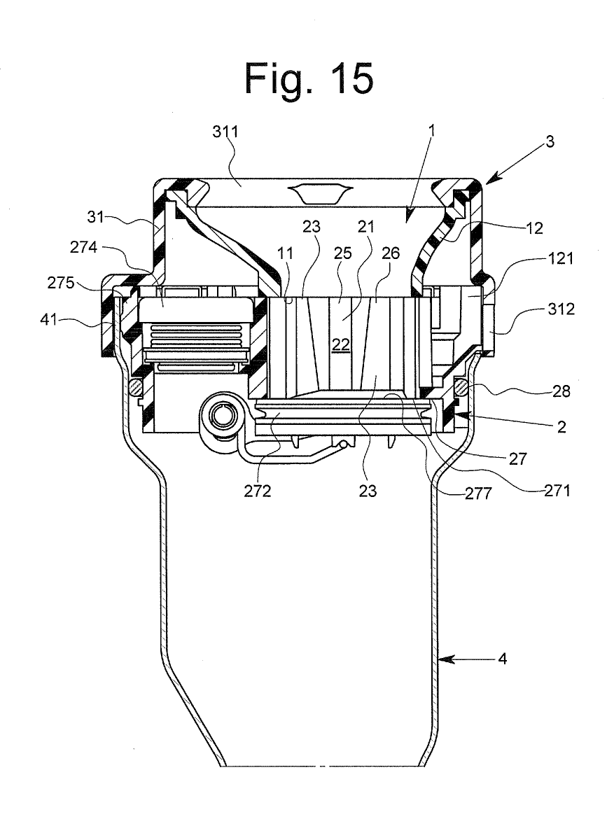

A second embodiment illustrated in FIGS. 7 to 10, a third embodiment illustrated in FIGS. 11 to 14, and a fourth embodiment illustrated in FIGS. 15 to 18 differ in a configuration of the guiding projections 21. However, these embodiments are the same as the first embodiment in that the flowing back fuel 6 is also guided to the outlet 23 and discharged from the second outlet 312 to the outside of the fuel filler pipe 4. The fuel 6 is guided to the outlet 23 by raising the pressure of the fuel passing through the gap between the first opening 11 and the fuel filler nozzle 5 and the between the guiding projection 21 and the fuel filler nozzle 5 as well. In other words, each embodiment differs only in a configuration of the second member 2, and does not differ in a configuration of the first member 1, the housing 31 and the end portion 41 of the pipe 4 as illustrated in FIGS. 2, 7, 11 and 15. Therefore respective second members are compatible with and replaceable between respective embodiments.

### SECOND EMBODIMENT OF FIGS. 7 TO 10

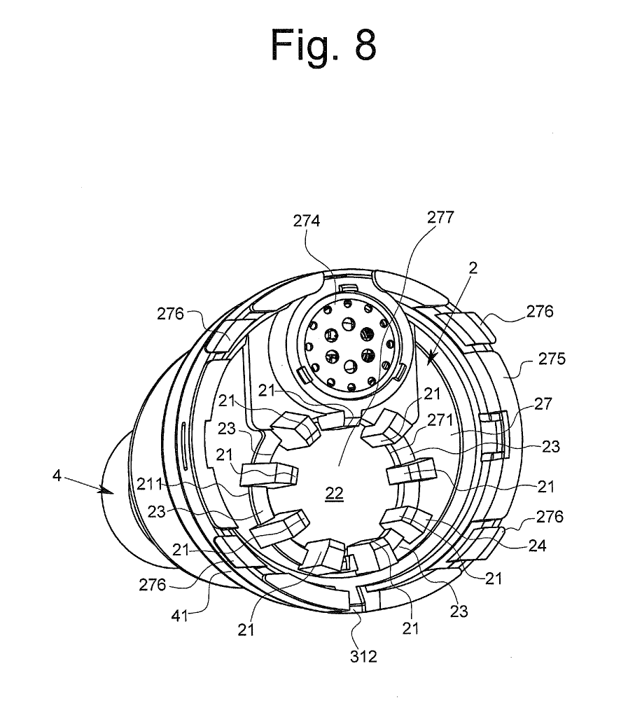

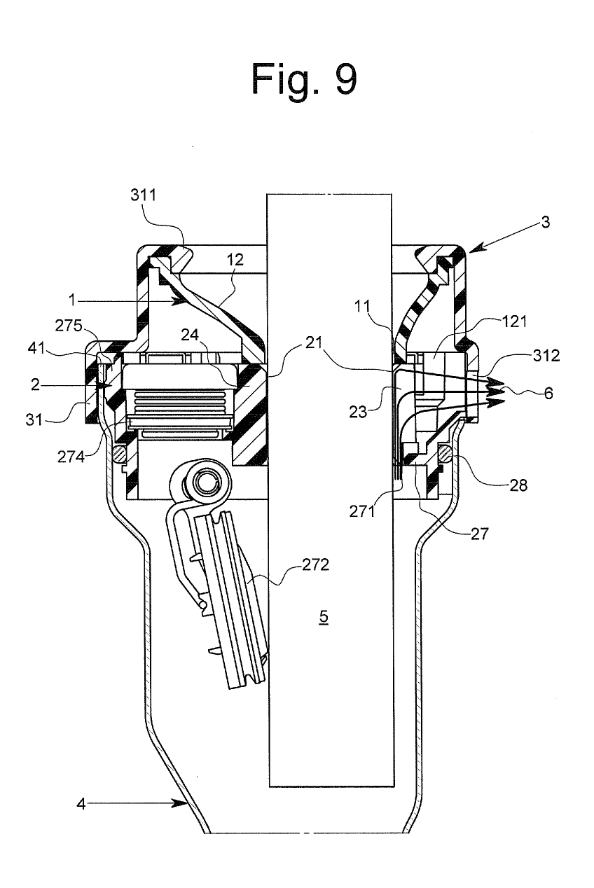

A second member 2 of the second embodiment has a cylindrical wall 24 whose inner diameter is equal to the outer diameter of the fuel filler nozzle 5 as illustrated in FIGS. 7 and 8. An outlet 23 is provided on the cylindrical wall 24. A remaining cylindrical wall 24 which is not provided with the fuel outlet 23 is a guiding projection 21. As illustrated in FIG. 8, the cylindrical wall 24 has a shape that a peripheral surface is completely removed except for a region in which the guiding projection 21 is provided. The fuel filler nozzle 5 is inserted into a space enclosed by the guiding projections 21. A circular rib 211 is provided on a bottom plate 27 surrounding the second opening 277 in order to reinforce a periphery of the second opening 277. The second opening 277 requires a mechanical strength as the valve sheet for the shutter 272 and a foundation for supporting the guiding projections 21. Since all of the cylindrical wall 24 is removed except for the region in which the guiding projection 21 is provided, the buffer space, which is provided between the fuel filler nozzle 5 and the cylindrical wall 24 in the first embodiment, is not provided around the fuel filler nozzle 5 in the second embodiment. Since the inner diameter of the cylindrical wall 24 is made smaller, the second member 2 can be downsized in the second embodiment. A gap is formed between the bottom plate 27 and the fuel filler nozzle 5 when the fuel filler nozzle is inserted into the second opening 277 as illustrated in FIG. 9. The gap is called a protruding opening 271 as well as in the first embodiment. In order to clearly depict a shape of the protruding opening 271, a state that the shutter 272 being downwardly pressed and opened is depicted in FIG. 8.

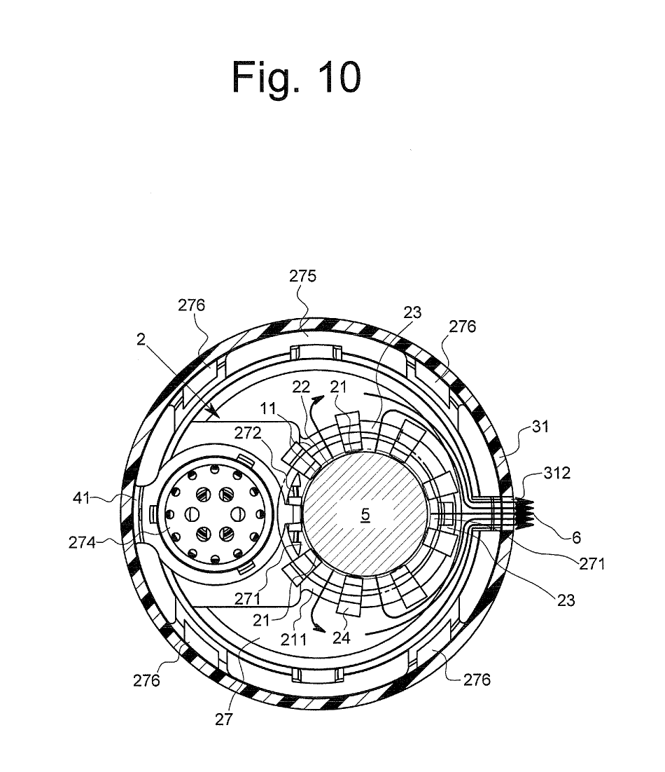

An inner diameter of the first opening 11 and a distance between the opposing guiding projections 21 is close to the outer diameter of the fuel filler nozzle 5 in the second embodiment as well as in the first embodiment. Therefore, as illustrated in FIGS. 9 and 10, the flowing back fuel 6 escapes and flows into the chamber 121 via the outlet 23 since the flowing back fuel hardly flows between the fuel filler nozzle 5 and the first opening 11 and between the fuel filler nozzle 5 and an inner surface of the guiding projection 21 where the pressure becomes high. The flowing back fuel 6 flows into the chamber 121 via the protruding opening 271 and the outlet 23. The flowing back fuel 6 is discharged from the chamber 121 to the outside of the fuel filler pipe 4 via the second outlet 121. Therefore, the flowing back fuel 6 does not overflow from the opening end 31 according to the fuel filler port 3 of the second embodiment.

### THIRD EMBODIMENT OF FIGS. 11 TO 14

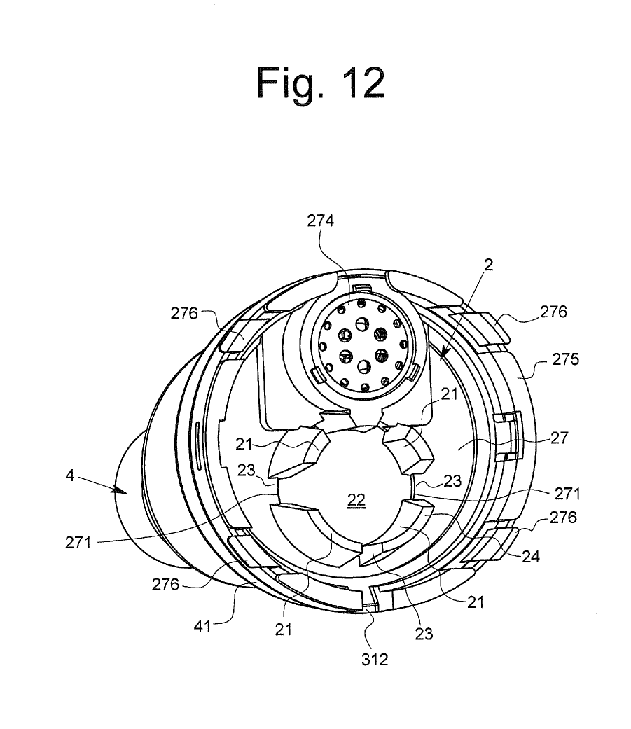

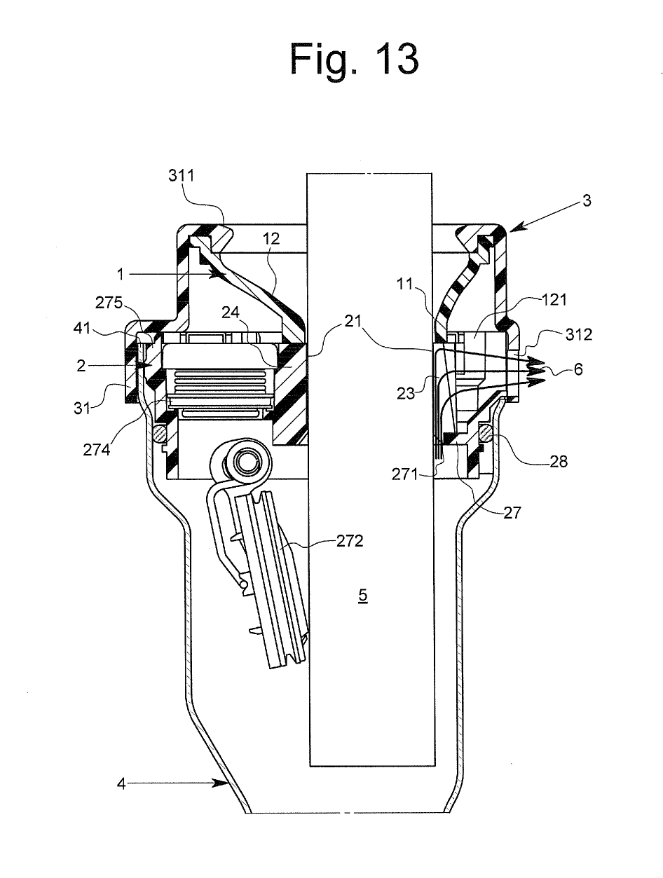

A second member 2 of the third embodiment has a cylindrical wall 24 whose inner diameter is equal to the outer diameter of the fuel filler nozzle 5 as illustrated in FIGS. 11 and 12. An outlet 23 is provided on the cylindrical wall 24. A remaining cylindrical wall 24 which is not provided with the fuel outlet 23 is a guiding projection 21. The fuel filler nozzle 5 is inserted into a space 22 enclosed by the guiding projections 21. Since a peripheral surface of the guiding members 21 is long in a circumferential direction, a periphery of the second opening 277 has an enough mechanical strength. Therefore, it is not necessary to provide any circular rib 211 around a periphery of the second opening 271 as in the case of the second embodiment (see FIG. 8). The second embodiment and the third embodiment are different each other in this regard. Since the inner diameter of the cylindrical wall 24 is made smaller, the second member 2 can be downsized in the third embodiment too. A gap is formed between the bottom plate 27 and the fuel filler nozzle 5 when the fuel filler nozzle is inserted into the second opening 277 as illustrated in FIG. 13. The gap is called a protruding opening 271 as well as in the first embodiment.

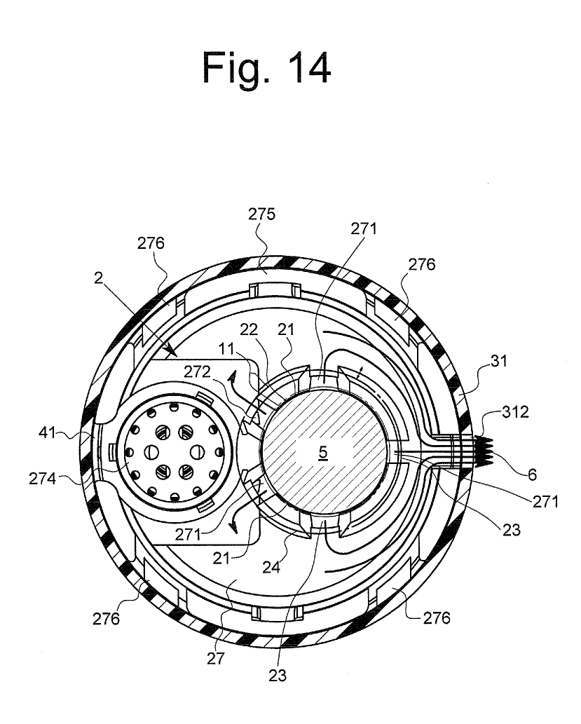

An inner diameter of the first opening 11 and a distance between the opposing guiding projections 21 is also close to the outer diameter of the fuel filler nozzle 5 in the third embodiment as well as in the first embodiment. Therefore, as illustrated in FIGS. 13 and 14, the flowing back fuel 6 escapes and flows into the chamber 121 via the outlet 23 since the flowing back fuel hardly flows between the fuel filler nozzle 5 and the first opening 11 and between the fuel filler nozzle 5 and an inner surface of the guiding projection 21 where the pressure becomes high. The flowing back fuel 6 flows into the chamber 121 via the protruding opening 271 and the outlet 23. The flowing back fuel 6 is discharged from the chamber 121 to the outside of the fuel filler pipe 4 via the second outlet 121. Therefore, the flowing back fuel 6 does not overflow from the opening end 31 according to the fuel filler port 3 of the second embodiment. The state the shutter 272 being downwardly pressed and opened is depicted in FIG. 12 for convenience of explanation.

### FOURTH EMBODIMENT OF FIGS. 15 TO 18

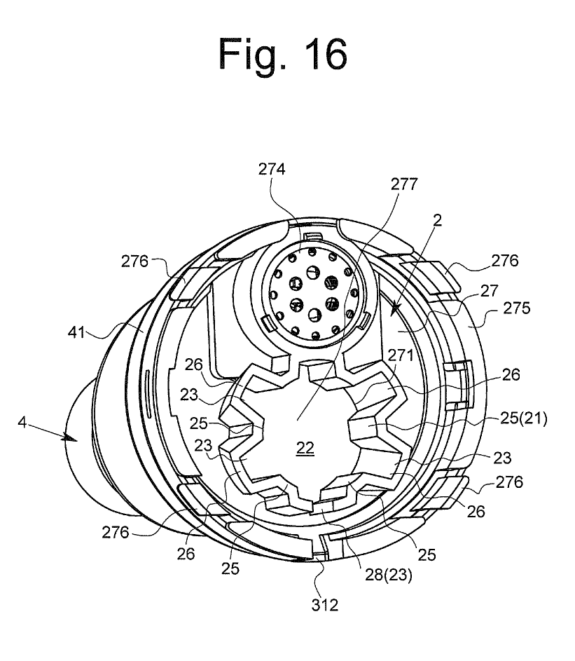

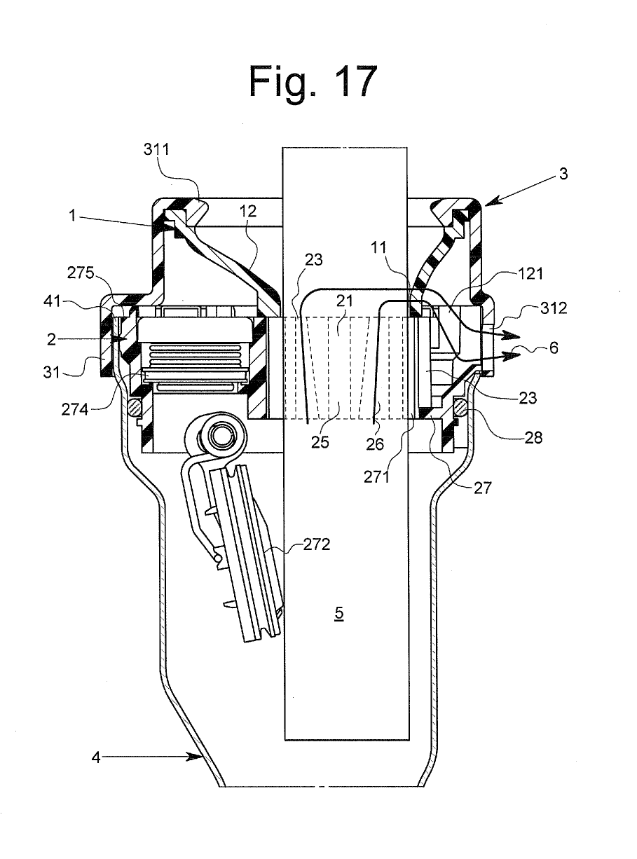

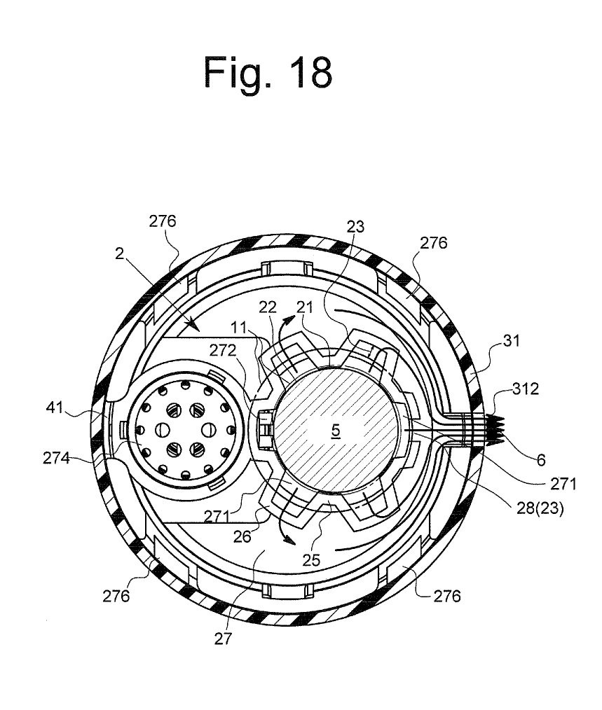

A second member 2 of a fourth embodiment has a plurality of projecting peripheral surfaces 25 and a plurality of concaved peripheral surfaces 26. The projecting peripheral surfaces 25 and the concaved peripheral surfaces 26 are combined and aligned alternately in a circumferential direction of the second opening 277. Inner surface of the projecting peripheral surface 25 is a guiding projection 21. The fuel filler nozzle 5 is inserted into a space 22 enclosed by the guiding projections 21. A liner distance between the opposing projecting peripheral surfaces 25 is equal to an outer diameter of the fuel filler nozzle 5. A liner distance between the opposing concaved peripheral surfaces 26 is larger than the outer diameter of the fuel filler nozzle 5 and an outer diameter of a lower end of the first member 1. The outer diameter of the lower end of the first member 1 is indicated with a dashed line on the outer side in FIG. 18. Because a periphery of the concaved peripheral surfaces 26 is radially-outwardly inclined to upward and the liner distance between the opposing concaved peripheral surfaces 26 is larger than the outer diameter of the lower end of the first member 1, i.e., an outer diameter of the lower end of the funnel 12, the gap is formed at an upper end of the concaved peripheral surface 26. This gap functions as an outlet 23 discharging the flowing back fuel 6. Although the concaved peripheral surface 26 has a slit 28 which functions as the outlet 23 too in an example of FIG. 16, the slit 28 can be omitted since the gap provided at the upper end of the concaved peripheral surface 26. A gap, which is different from the aforementioned gap at the upper end of the concaved peripheral surface 26, is formed between the bottom plate 27 and the fuel filler nozzle 5 when the fuel filler nozzle is inserted into the second opening 277 as illustrated in FIG. 17. The gap is called a protruding opening 271 as well as in the first embodiment.

An inner diameter of the first opening 11 and a distance between the opposing guiding projections 21 is also close to the outer diameter of the fuel filler nozzle 5 in the fourth embodiment as well as in the first embodiment. Therefore, as illustrated in FIGS. 17 and 18, the flowing back fuel 6 escapes and flows into the chamber 121 via the outlet 23 since the flowing back fuel hardly flows between the fuel filler nozzle 5 and the first opening 11 and between the fuel filler nozzle 5 and an inner surface of the guiding projection 21 where the pressure becomes high. The flowing back fuel 6 flows into the chamber 121 via the protruding opening 271 and the outlet 23. The flowing back fuel 6 is discharged from the chamber 121 to the outside of the fuel filler pipe 4 via the second outlet 121. Therefore, the flowing back fuel 6 does not overflow from the opening end 31 according to the fuel filler port 3 of the fourth embodiment. The state the shutter 272 being downwardly pressed and opened is depicted in FIG. 16 for convenience of explanation.

What we claim is:

1. A fuel filler port to be installed on an end of a fuel filler pipe communicated with a fuel filler tank, the fuel filler port comprising:
a first member placed across an inserting direction of a fuel filler nozzle and provided with a first opening for inserting the fuel filler nozzle, an inner diameter of the first opining being equal to an outer diameter of the fuel filler nozzle; and
a second member placed across an inserting direction of the fuel filler nozzle and provided with a second opening for inserting the fuel filler nozzle, a plurality of guiding projections forming a space for guiding the fuel filler nozzle to the fuel filler pipe and intermittently projecting from a peripheral edge of the second opening, a protruding opening protruding radially-outwardly from the second opening and provided between the adjacent guiding projections, and a fuel outlet provided between the adjacent guiding projections and communicating with the space enclosed by said guiding projections and an outside of the fuel filler pipe; wherein
the first member and the second member are provided from upward to downward in written order, and a flowing back fuel is discharged through the protruding opening and the fuel outlet to the outside.

2. The fuel filler port according to claim 1,
further comprising a chamber communicating with the space enclosed by said guiding projections via the fuel outlet,
and a second fuel outlet provided within the chamber to communicate with the space outside the fuel filler pipe.

3. The fuel filler port according to claim 1,
further comprising a flow changing block colliding with a fuel run off from the fuel outlet and changing a flow direction in the circumferential direction, wherein the flow changing block is provided on outside of the fuel outlet to face the fuel outlet.

4. The fuel filler port according to claim 1, wherein
the guiding projections radially-inwardly protrude from a peripheral face of a cylindrical wall whose inner diameter is larger than outer diameter of the fuel filling nozzle, and
the fuel outlet is provided on the peripheral surface on which the guiding projections are not provided.

5. The fuel filler port according to claim 1, wherein
the fuel outlet is provided on the peripheral surface of a cylindrical wall whose inner diameter is equal to a outer diameter of the fuel filling nozzle, and the guiding projections are remaining cylindrical walls which are not provided with the fuel outlet.

6. The fuel filler port according to claim 1, wherein
the second opening is provided with a plurality of projecting peripheral surfaces and a plurality of concaved peripheral surfaces, the projecting peripheral surfaces and the concaved peripheral surfaces are combined and aligned alternately in a circumferential direction of the second opening, a distance between inner surfaces of the opposing concaved peripheral surfaces is larger than an outer diameter of the fuel filling nozzle and an outer diameter of a lower end of the first member, a distance between the inner surfaces of the opposing projecting peripheral surfaces is equal to the outer diameter of the fuel filling nozzle,
the guiding projections are said projecting peripheral surfaces, and the fuel outlet is an opening between an upper end of the concaved peripheral surface and the lower end of the first member.

7. The fuel filler port according to claim 1, further comprising a shatter, wherein
the guiding projections radially-inwardly protrude from a peripheral edge of second opening to form the protruding opening between the adjacent guiding projections, and the protruding opening is communicated with the second opening, and the shatter is pressed against the second opening and the protruding opening as a valve sheet.
